(19) United States
(12) Patent Application Publication
(10) Pub. No.: US 2018/0092403 A1
(43) Pub. Date: Apr. 5, 2018

(54) VAPORIZING DEVICE FOR HOOKAH

(71) Applicant: Wael Salim ELHALWANI, Dubai (AE)

(72) Inventor: Wael Salim ELHALWANI, Dubai (AE)

(21) Appl. No.: 15/820,371

(22) Filed: Nov. 21, 2017

Related U.S. Application Data
(63) Continuation-in-part of application No. 14/537,842, filed on Nov. 10, 2014.
Application No. 14/537,842 is a continuation-in-part of application No. 14/537,842, filed on Nov. 10, 2014.
(60) Provisional application No. 61/962,599, filed on Nov. 8, 2013.

(51) Int. Cl. A24F 47/00; H05B 1/02; H05B 3/46; A24F 1/30; H04R 1/02

(52) U.S. Cl. CPC A24F 47/008; H05B 1/0297; H04R 2420/07; A24F 1/30; H04R 1/028; H05B 3/46

(57) ABSTRACT

A vaporizing device used for hookah includes an atomizer to produce vapor when a user begins to inhale smoke from the vaporizing device. The atomizer includes a mesh dome that regulates liquid flow from a cartridge and into contact with a plurality of heating coils.

### CROSS-REFERENCE TO RELATED APPLICATION

This application is a continuation-in-part (CIP) of, and claims priority to, U.S. non-provisional application Ser. No. 14/537,842, filed on Nov. 10, 2014, which claims the benefit of, and priority to, U.S. provisional application No. 61/962,599, filed on Nov. 8, 2013. The subject matter thereof is hereby incorporated herein by reference in its entirety.

### FIELD

The present invention relates to a vaporizing device for hookah.

### BACKGROUND

A growing number of teens and young adults are using a water pipe known in the Middle East as hookah or shisha for social activities. FIG. 1 is related art illustrating a conventional hookah 100. Hookah 100 includes a bowl 102, a plate 104, a body 106, a jar 112, a hose 114, and a mouthpiece 116. Bowl 102 generally holds tobacco and charcoal, which is burned during smoke. Bowl 102 is composed of clay or marble.

Plate (or ashtray) 104 captures falling ash or dead coal while a person is smoking. Body 106 is a hollow tube with a gasket 108 at the bottom. Gasket 108 has an opening for a hose 114 and seals connection of body 106 with jar 112. Jar 112 contains water (not shown), allowing smoke from tobacco passing through jar 112, gaining moisture, and lowering the temperature of the smoke before the smoke reaches hose 114. Hose 114 is a slender tube allowing smoke to be drawn, and is typically fitted with a metal, wooden, or plastic mouthpiece 116.

During operation, a user inhales air by way of hose 114. The air is pulled through the coal and into bowl 102. Hot air from the charcoal burns tobacco, producing smoke. The smoke passes through the body tube, extending into jar 112. The smoke bubbles up to the top of the water, and into a channel connected to hose 114 by way of a valve 110. When the user inhales from hose 114, pressure in jar 112 changes. This pressure change results in pulling more air through the charcoal and continuing the process described above.

However, with hookah 100, a user tends to inhale more smoke over a longer period of time compared to cigarette smoking. This may lead to an increase in carbon dioxide and nicotine exposure, and may contribute to heart disease and cancer. Furthermore, hookah 100 is not portable, preventing the user from using hookah 100 while on the go.

Thus, an alternative process for reducing health risks and increasing portability may be beneficial.

### SUMMARY

Certain embodiments of the present invention may provide solutions to the problems and needs in the art that have not yet been fully identified, appreciated, or solved by current hookah devices. Some embodiments generally pertain to a portable vaporizing device used for hookah. The vaporizing device may include at least one longitudinal member coupled to an energy source. The at least one longitudinal member may receive at least one vaporizable element to be vaporized by a heat source. The at least one longitudinal member may include at least one chamber for channeling the vapor to the outside environment by way of a mouthpiece.

In an embodiment, a vaporizing device may be used for hookah. The vaporizing device includes an atomizer to produce vapor when a user begins to inhale smoke from the vaporizing device. The atomizer includes a mesh dome that regulates liquid flow from a cartridge when the liquid contacts with a plurality of heating coils.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is related art illustrating a conventional hookah.

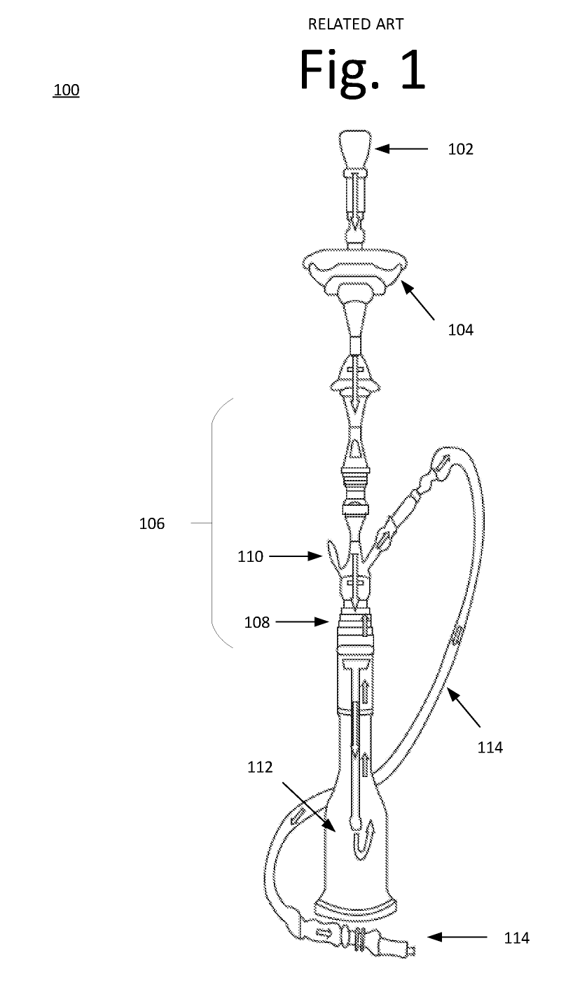

FIG. 2A illustrates a cross-sectional view of hookah vaporizing device, according to an embodiment of the present invention.

FIG. 2B illustrates a prospective view of hookah vaporizing device, according to an embodiment of the present invention.

FIG. 2C illustrates a prospective view of a vaporizing device without a cap, according to an embodiment of the present invention.

FIG. 2D illustrates a top view of a vaporizing device without cartridges, according to an embodiment of the present invention.

FIG. 2E illustrates a prospective view of a vaporizing device with cartridges inserted therein, according to an embodiment of the present invention.

FIG. 2F illustrates a side view of a cap for the vaporizing device, according to an embodiment of the present invention.

FIG. 3 illustrates a cartridge for the vaporizing device, according to an embodiment of the present invention.

FIG. 4 illustrates various components of the vaporizing device, according to an embodiment of the present invention.

FIG. 5 is a block diagram illustrating a speaker system for vaporizing device, according to an embodiment of the present invention.

### DETAILED DESCRIPTION OF THE EMBODIMENTS

Some embodiments generally pertain to a vaporizing device. In some embodiment, vaporizing device may be known as an electronic hookah or “hookah”). The vaporizing device may be as small as a user's palm or large enough to be held by both hands. The vaporizing device may include an atomizer that allows the user to inhale vapor from the vaporizing device. As the user inhales the vapor, a power source creates solid contact with positive and negative wires extending from a casing of the atomizer. This contact powers the vaporizing device. As liquid is pulled from the cartridge and flows into contact with heating coils, vapor is produced within the casing of the atomizer. The vapor may be odorless, and may simulate smoke that quickly dissipates in the air when exhaled by the user. The vapor may flow out through the mouthpiece and into the user's body. This vaporizing device may produce a cloud of nicotine carrying the vapor with none of the toxicity of tobacco burning by-products.

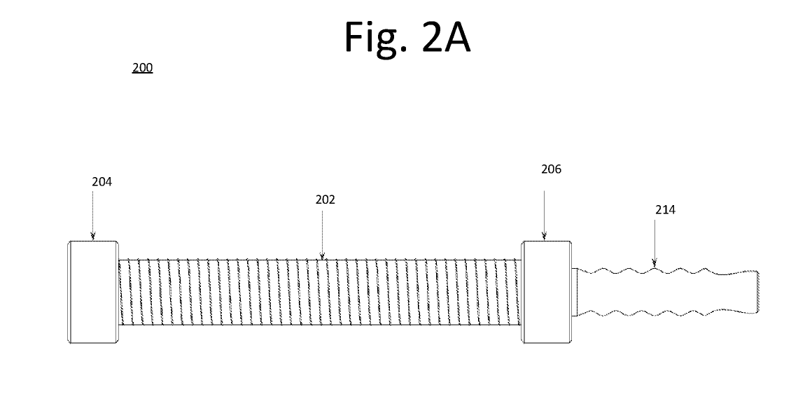

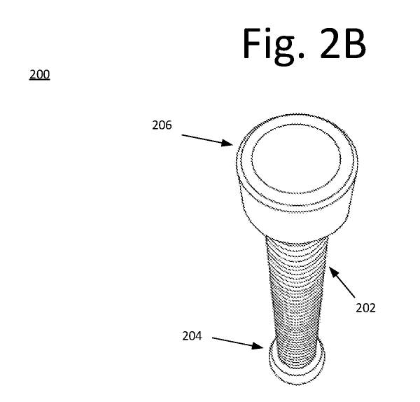

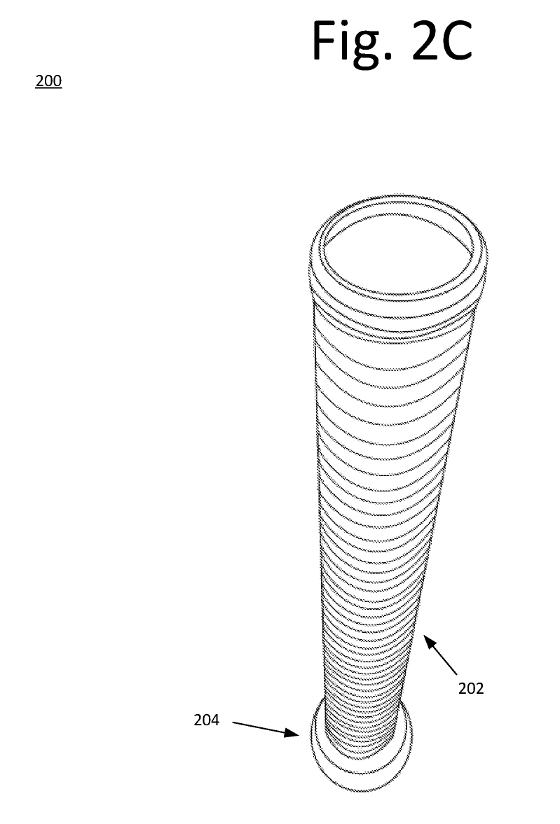

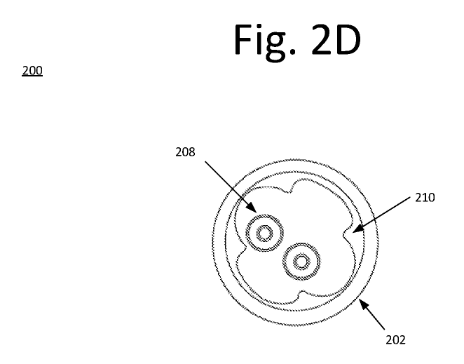

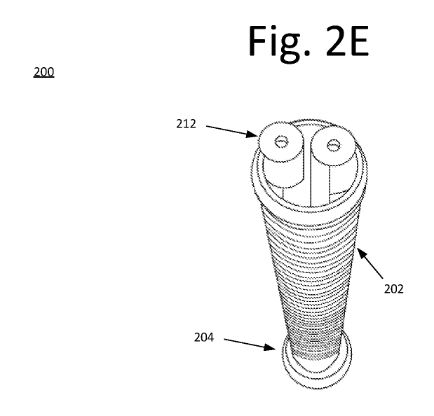

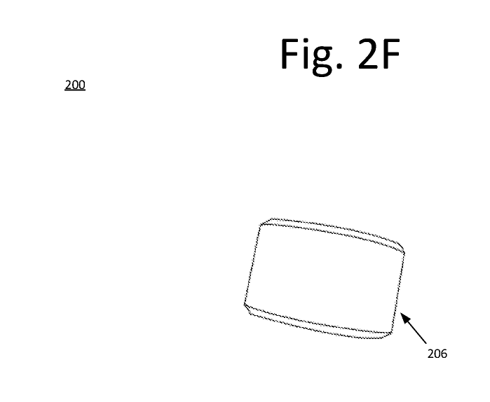

FIG. 2A illustrates a cross-sectional view of a vaporizing device 200, according to an embodiment of the present invention. In some embodiment, vaporizing device 200 may include a housing (or body/tube) 202. Housing 202 may be in the form of a cylinder, which is large enough to be held in the palm of a user's hand, and may have a cross-section of a typical hookah tube. It should be appreciated, however, that housing 202 is not limited to a cylindrical design.

An end cap 204 is placed on one end of housing 202 and a cover 206 is placed on the other end of housing 202. As shown in FIG. 2B, vaporizing device 200 may be placed vertically by using end cap 204 as its base. Similarly, cover 206 may be used to place vaporizing device 200 vertically.

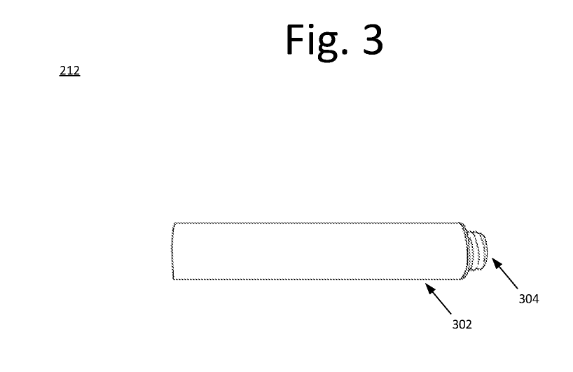

In some embodiments, end cap 204 may be removable, allowing the power source (not shown) to be replaced or recharged. Cover 206 may also be removable, allowing the cartridge(s) (not shown) to be removed or replaced. See, for example, FIGS. 2C and 2D. For example, as shown in FIG. 2D, vaporizing device 200 may include female connectors 208 allowing cartridges to connect within housing 200. FIG. 3 illustrates a cartridge 212 for the vaporizing device, according to an embodiment of the present invention. In some embodiment, cartridge 212 may include a canister portion 302 containing liquid for use in the vaporizing device and a male connector 304. Male connector 304 may connect with female connector 208 by way of twisting or sliding. See, for example, FIG. 2E.

To limit cartridge movement within housing 202, material 210 may be positioned around the cartridge area. Material 210 may be composed of rubber or some soft structure to limit movement and damage, for example. Regarding of the type of material that is being used, there must be sufficient space between material 210 and cartridges 212 to allow vapor to pass through to mouthpiece 214.

In certain embodiments, cover 206 may affix mouthpiece 214 to vaporizing device 200. See FIG. 2B. By using a removable mouthpiece 214, the user can replace mouthpiece 214 with another mouthpiece improving hygiene. See FIG. 2A. Removable mouthpiece 214 may be composed of plastic or any type of material that would be appreciated by a person of ordinary skill in the art.

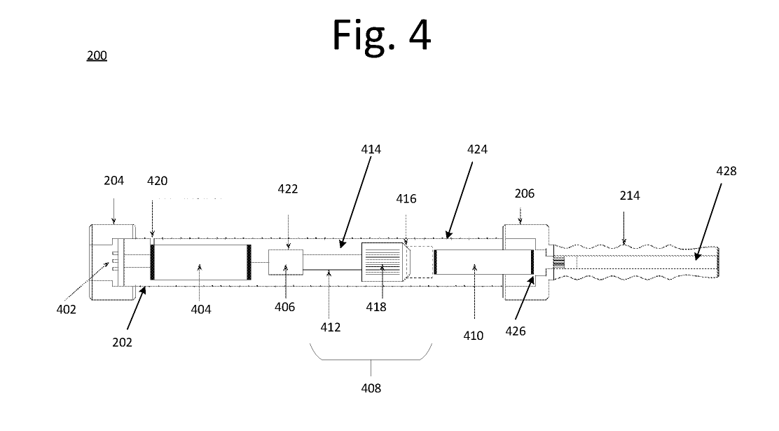

FIG. 4 is schematic diagram illustrating a cross-section of vaporizing device 200 of FIG. 2A, according to an embodiment of the present invention. In an embodiment, housing 202 of FIG. 2A may include a power source 404. Power source 404 may provide sufficient power to one or more components within vaporizing device 200. For example, light emitting diode (LED) 402 and atomizer 408 may receive power from power source 404. LED 402 may indicate proper operation of vaporizing device 200, as well as other signals, such as low battery or power. A power adaptor input 420 may provide a connection between a charger and vaporizing device 200. This way, when power is low, power source 404 can be charged.

In an embodiment, vaporizing device 200 may include a cartridge 410 that contains fluid with low boiling temperatures. In another embodiment, vaporizing device 200 may include more than one cartridge with the same flavor or different flavors and/or scents. See, for example, FIG. 2E. The fluid may include propylene glycol (PG), vegetable glycerin (VG), polyethylene glycol 400 (PEG400), or any other alternative fluid or combination thereof. For purposes of explanation, the term “cartridge” will be used.

Atomizer 408 may be situated between power source 404 and cartridge 410 to facilitate operations of vaporizing device 200. For example, when a user inhales from vaporizing device 200, power source 404 creates contact with positive wire 412 and negative wire 414. Positive wire 412 and negative wire 414 may extend out from atomizer 408 and connect with pressure sensor-voltage connector (PSVC) 406.

PSVC 406 may detect change in pressure, electrically connecting power source 404 with atomizer 408. For example, when the user begins to inhale from vaporizing device 200, PSVC 406 may detect a change in pressure created from the inhalation. This in turn activates power source 406, causing the power from power source 306 to activate heating coils 318 and LEDs 402. In some embodiment, heating coils 318 are heated to a predefined temperature vaporizing the liquid flowing from cartridge 410.

In some embodiments, liquid from cartridge 410 may flow into mesh dome 416 when the user begins to inhale from vaporizing device 200. For example, mesh dome 416 may control the amount of liquid that travels to heating coil 418. As the liquid enters mesh dome 416, the liquid contacts heating coils 418 to produce vapor within mesh dome 416. The vapor may escape through a passageway 424 and out through passageway 428 of mouthpiece 214. Passageway 424 may be formed between cartridge 410 and vaporizing device 200. In certain embodiments, passageway 424 is an open space created within vaporizing device 200 and the exterior of cartridge 410. To ensure that all of the vapor does not flow out at once, orifice(s) or gap(s) 426 may regulate the flow of the vapor. Orifice(s) or gap(s) 424 may be formed by the space created between exterior corners of cartridge 410 and interior corners of vaporizing device 200.

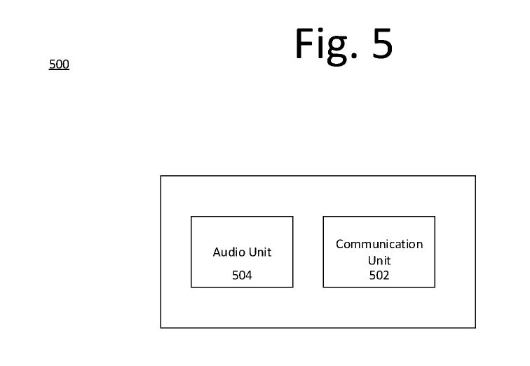

PSVC 406 in some embodiments may include a speaker connection 422. Speaker connection 422 may allow an external radio to physically connect with vaporizing device 200. In an alternative embodiment, an internal speaker built within, or separate from, PSVC 406 may connect via Bluetooth™ when vaporizing device 200 is being used by the user. See, for example, FIG. 5, which is a block diagram illustrating a speaker system 500 for vaporizing device 200, according to an embodiment of the present invention. In some embodiment, speaker system 500 may include a communication unit 502 that wirelessly connects via WIFI or Bluetooth™ to a mobile device, for example. Once vaporizing device 200 is connected to the mobile device, audio from the mobile device may be played from audio unit 504. In other words, speaker system 500 allows music to be heard from vaporizing device 200 while being controlled by a user's mobile device.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A vaporizing device for hookah, comprising:
an atomizer configured to produce vapor when a user begins to inhale smoke from the vaporizing device; wherein
the atomizer comprises a mesh dome configured to regulate liquid flow from a cartridge and into contact with a plurality of heating coils.

2. The vaporizing device of claim 1, wherein the plurality of heating coils are configured to produce vapor upon contact with the liquid within the mesh dome.

3. The vaporizing device of claim 1, wherein the mesh dome is comprised of metal to regulate liquid flow.

4. The vaporizing device of claim 1, further comprising:
a power source configured to provide power to the atomizer, light emitting diode (LED), or both.

5. The vaporizing device of claim 4, wherein when the user inhales from the vaporizing device, the power source connects with a positive wire and a negative wire extending out of the atomizer and connecting with a pressure sensor-voltage connector (PSVC).

6. The vaporizing device of claim 5, wherein when the PSVC detect change in pressure upon inhalation from the user, the PSVC is configured to electrically connect the power source with the atomizer.

7. The vaporizing device of claim 6, wherein when the atomizer electrically connects with the power source, the plurality of heating coils are heated to a predefined temperature, vaporizing the liquid.

8. The vaporizing device of claim 1, further comprising:
one or more cartridges comprising liquid, wherein
the liquid within the one or more cartridges comprise same flavor or scent or different flavor or scent.

9. The vaporizing device of claim 1, further comprising:
a light emitting diode (LED) configured to emit light when the user begins to inhale from the vaporizing device.

10. The vaporizing device of claim 1, further comprising:
a passageway created within the vaporizing device and an exterior of the cartridge, wherein
the passageway is configured to allow vapor to escape from the mesh dome and out through a passageway of a mouthpiece.

11. The vaporizing device of claim 10, further comprising:
one or more orifices within the passageway of the vaporizing device to regulate flow of the vapor into the passageway of the mouthpiece.

12. The vaporizing device of claim 11, wherein the one or more orifices are formed by a space created between exterior corners of the cartridge and interior corners of the vaporizing device.

13. A portable vaporizing device for hookah, comprising:
an atomizer configured to produce vapor when a user begins to inhale smoke from the vaporizing device; wherein
the atomizer comprises a mesh dome configured to regulate liquid flow from a plurality of cartridges and into contact with a plurality of heating coils, and
the plurality of heating coils are configured to produce vapor upon contact with the liquid within the mesh dome.

14. The vaporizing device of claim 13 wherein the mesh dome is comprised of metal to regulate liquid flow.

15. The vaporizing device of claim 13, further comprising:
a power source configured to provide power to the atomizer, light emitting diode (LED), or both.

16. The vaporizing device of claim 15, wherein when the user inhales from the vaporizing device, the power source connects with a positive wire and a negative wire extending out of the atomizer and connecting with a pressure sensor-voltage connector (PSVC).

17. The vaporizing device of claim 16, wherein when the PSVC detect change in pressure upon inhalation from the user, the PSVC is configured to electrically connect the power source with the atomizer.

18. The vaporizing device of claim 17, wherein when the atomizer electrically connects with the power source, the plurality of heating coils are heated to a predefined temperature, vaporizing the liquid.

19. The vaporizing device of claim 13, further comprising:
one or more cartridges comprising liquid, wherein
the liquid within the one or more cartridges comprise same flavor or scent or different flavor or scent.

20. The vaporizing device of claim 13, further comprising:
a passageway created within the vaporizing device and an exterior of the cartridge, wherein
the passageway is configured to allow vapor to escape from the mesh dome and out through a passageway of a mouthpiece.

21. The vaporizing device of claim 13, further comprising:
a speaker system comprising
a communication unit configured to wirelessly connect with a mobile device of the user, and
an audio unit configured to play audio from the vaporizing device while being controlled by the mobile device.
